(19) United States
(12) Patent Application Publication
(10) Pub. No.: US 2017/0124161 A1
(43) Pub. Date: May 4, 2017

(54) PRESENTATION OF DIGITAL DATA

(71) Applicant: eBay Inc., San Jose, CA (US)

(72) Inventor: Junlong Wu, Shanghai (CN)

(21) Appl. No.: 14/930,143

(22) Filed: Nov. 2, 2015

(51) Int. Cl. G06F 17/30; G06F 3/0484; G06F 3/0482

(52) U.S. Cl. CPC G06F 17/30554; G06F 3/0482; G06F 3/04842; G06F 17/30867

(57) ABSTRACT

A computer-implemented method of digital information presentation may include obtaining a digital request for presentation of digital data from a digital database and providing a digital user interface for presentation of the digital data. The user interface may include multiple condition elements that each may be associated with one data field in the digital data. The method may also include obtaining a selection of one of the condition elements and providing a selection element associated with multiple values from the digital data that are selected from the data field associated with the selected condition element. The method may further include obtaining a selection of one of the multiple values, querying the digital database to determine a subset of the digital data with the selected value in the data field associated with the selected condition element, and providing the subset of the digital data by way of the user interface.

### FIELD

The embodiments discussed herein are related to presentation of digital data.

### BACKGROUND

As an ever-increasing amount of information is being made available electronically, typically over networks such as the Internet, it is increasingly difficult to locate information or other content that may be of interest to a user. Sometimes there is too much information to present to a user on a single screen. In these situations, the information is divided into discrete pages and the user is able to select the individual pages to view the information. How the information is divided into the discrete pages may be arbitrary or uncorrelated with why the user selected the information.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system configured to present digital information;

FIGS. 2a-2e illustrates examples of different configurations of a digital user interface that presents digital information;

FIG. 3 illustrates another example system configured to present digital information;

FIG. 4 is a flowchart of an example computer-implemented method of digital information presentation; and

FIG. 5 is a flowchart of another example computer-implemented method of digital information presentation.

### DESCRIPTION OF EMBODIMENTS

Some embodiments herein relate to a computer-implemented method of digital information presentation. For example, a digital database may be queried for information. The digital database may be a cloud database configured to store information accessed over the Internet. For example, the digital database may store retail information for an on-line retailer. Alternately or additionally, the digital database may store health information, finance information, among other consumer information. Alternately or additionally, the digital database may store information used by a company or individual for business, such as on-line file storage, among other types of information.

Before the queried information is provided for presentation, a digital user interface may present condition elements associated with data fields in data entries that are responsive to the information query. Based on a selection of one of the condition elements, the digital user interface may present a selection element. The selection element may be associated with multiple values selected from the data field associated with the selected condition element. For example, the selection element may display a lowest value, a highest value, and other values from the data field associated with the selected condition element. A selection of a value from the selection element may be received. Based on the selection of the value, the digital database may provide the data entries that are associated with the selected values, for example the data entries with data values that match the selected data values, for presentation by the digital user interface.

In these and other embodiments, by allowing a selection of a particular value associated with the data entries in the digital database, the digital user interface may provide data entries that may be more relevant to a user. By providing data entries more relevant to a user, the digital user interface may reduce network traffic, data load times, and/or a complexity of the digital user interface design as compared to other systems. For example, in some systems, if a query results in multiple data entries that cannot all be displayed on a screen at one time, the system may digitally paginate the resulting data entries. The number of pages may be unknown until the query request, resulting in the calculation of the number of digital pages and setting a user interface with the correct number of page options in real-time. This real-time processing may increase the processing and the load times to present the information as well as the complexity of the user interface. Furthermore, the pagination may not be sorted based on criteria useful for the user, such that the user may click on multiple pages to find desired information. Each page click may result in network traffic to retrieve the information associated with the selected page. As a result, multiple groups of data entries associated with the different pagination pages may be retrieved before the desired information is located. The retrieval of multiple grouping of data entries may increase the network traffic between the digital database and a user device that is presenting the information to the user.

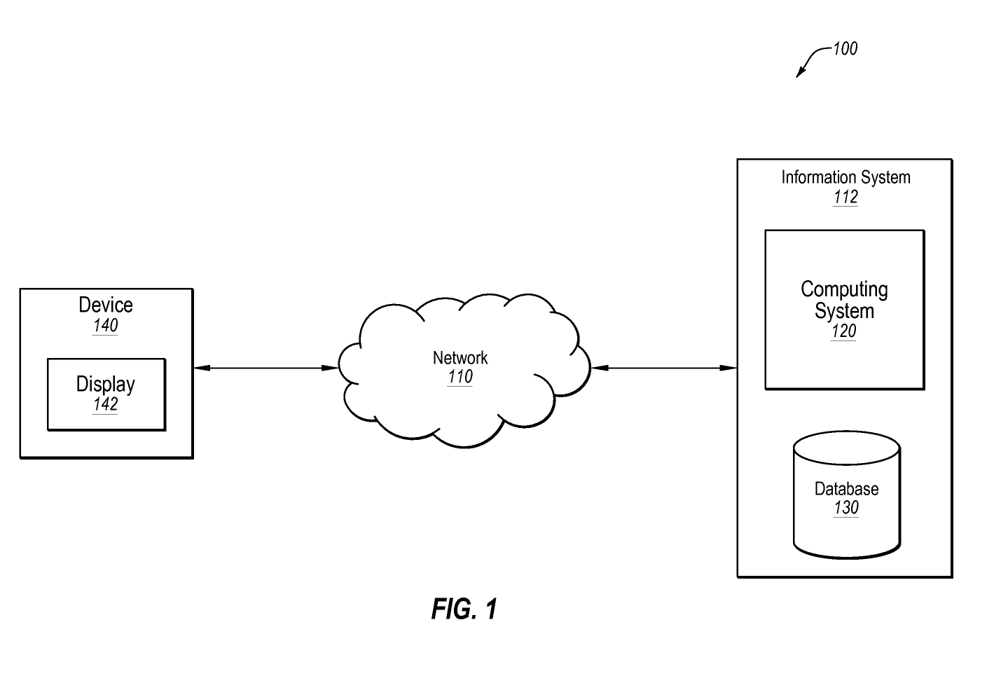

Turning to the figures, FIG. 1 illustrates an example system 100 configured to present digital information. The system 100 may be arranged in accordance with at least one embodiment described in the present disclosure. The system 100 may include a network 110, an information system 112 that includes a computing system 120 and a database 130, and a device 140 that includes a display 142.

The network 110 may be configured to communicatively couple the information system 112 with the device 140. In some embodiments, the network 110 may be any network or configuration of networks configured to send and receive communications between devices. In some embodiments, the network 110 may include a conventional type network, a wired or wireless network, and may have numerous different configurations. Furthermore, the network 110 may include a local area network (LAN), a wide area network (WAN) (e.g., the Internet), or other interconnected data paths across which multiple devices and/or entities may communicate. In some embodiments, the network 110 may include a peer-to-peer network. The network 110 may also be coupled to or may include portions of a telecommunications network for sending data in a variety of different communication protocols. In some embodiments, the network 110 may include Bluetooth® communication networks or a cellular communications network for sending and receiving communications and/or data including via short message service (SMS), multimedia messaging service (MMS), hypertext transfer protocol (HTTP), direct data connection, wireless application protocol (WAP), e-mail, etc. The network 110 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 110 may include one or more IEEE 802.11 wireless networks.

The device 140 may be any electronic device configured to provide a user with access to one or more systems, which may include one or more servers and databases, through a network. For example, the device 140 may include a desktop computer, a laptop computer, a smartphone, a mobile phone, a tablet computer, or any other processing device configured to access information over a network or internally. In some embodiments, the device 140 may be configured to receive digital data from the information system 112 and present the digital data to a user of the device 140. In these and other embodiments, the device 140 may present the information visually using a display 142. Alternately or additionally, the device may present the information in audio, by tactile response, or by some other method.

In some embodiments, the information system 112 may be any configuration of hardware, such as servers and databases that are networked together and configured to perform a task. In some embodiments, the computing system 120 may be a single computing system that includes one or more processors and memory, such as a server or some other computing system, within the information system 112. Alternately or additionally, the computing system 120 may include multiple computing systems, such as multiple servers, that are networked together and configured to perform a task within the information system 112. Alternately or additionally, the computing system 120 may include computing systems and/or computer-readable-instructions that are configured to be executed by the information system 112 to perform the operations described in this disclosure. The database 130 may be any configuration of digital data storage.

In some embodiments, the information system 112 may be configured to provide a user, through the device 140, with an ability to browse or search for information, services, or goods listed or included within the database 130 of the information system 112.

For example, the information system 112 may be configured as an online marketplace for a seller or sellers to sell goods to buyers. In these and other embodiments, the database 130 may include listings of goods or services to be sold that may be accessed by a user through a device, such as the device 140. Alternately or additionally, the database 130 may include information regarding an account of a seller or buyer on the online marketplace. In some embodiments, the information system 112 may allow the device 140 to browse through the listings of goods, services, buyer or seller information, or search for any information in the database 130.

Alternately or additionally, the information system 112 may be configured as another client or user centric type system. In these and other embodiments, the database 130 may include other information that may be accessed by the device 140. For example, the information may be business information related to files maintained by a business, health care information, financial information, among other types of information.

In some embodiments, the computing system 120 may be configured to handle digital requests for presentation of digital data from the database 130. For example, a user may be accessing the information system 112 via the device 140 and the network 110. Based on the interaction with the information system 112, the user may send a digital request for information. For example, if the information system 112 is an online marketplace, the user may request information regarding items sold. As another example, if the information system 112 is a business database or document database, the user may request all information/documents pertaining to a certain business matter.

In general, the computing system 120 may be configured to handle the digital requests for information. In some embodiments, the digital request may include a request for information with multiple data entries in the database 130. In these and other embodiments, the computing system 120 may search the database 130 to determine the data entries in the database 130 that may fulfill the request. The computing system 120 may not send all of the data entries in the database 130 that may fulfill the request. Rather, the computing system 120 may be configured to obtain culling information from the requested data entries. The culling information may be used by a digital user interface to present various elements in the digital user interface.

The computing system 120 may provide the culling information to the device 140. Using the culling information, the device 140 may configure elements in a digital user interface and may present the digital user interface to a user. The device 140 may also obtain one or more user selections based on the elements in the digital user interface and may provide the user selections to the computing system 120. The computing system 120 may cull the data entries in the database 130 that fulfill the request based on the user selections and may provide the culled data entries to the device 140 for presentation to the user.

Alternately or additionally, the computing system 120 may determine a number of data entries in the database 130 that fulfill the request. When the number of data entries in the database 130 that fulfill the request is below a threshold, the computing system 120 may send all of the data entries in the database 130 that fulfill the request. When the number of data entries in the database 130 that fulfill the request is above the threshold, the computing system 120 may not send all of the data entries, but may obtain and send the culling information as previously indicated. In some embodiments, the threshold may be based on the device 140 that transmitted the request. For example, the threshold may be based on a size of the display 142 of the device 140. When the size of the display 142 is larger the threshold may be larger and vice versa. Alternately or additionally, the threshold may be based on the connection speeds between the device 140 and the computing system 120 over the network 110. When the connection speeds are higher, the threshold may be higher and vice versa.

In some embodiments, the culling information obtained from the requested data entries by the computing system 120 may be based on the data fields within the data entries. For example, the culling information may include identifier information for data fields within the data entries and values within the data fields. The data fields selected for the culling information may be the data fields that may include data values to further sort the data entries that fulfill the digital request. The values selected for the culling information may include a minimum and/or maximum value in the data field of the data entries that fulfill the digital request. In some embodiments, the data fields included in the culling information may be determined by the computing system 120. Alternately or additionally, the data fields included in the culling information may be determined in part or wholly by a user of the computing system 120.

For example, if the information system 112 is an online marketplace and the user is a seller on the online marketplace, the digital request may be a request for a listing of items sold by the seller. The database 130 may include data entries for each item sold in the online marketplace. The data entries in the database 130 may include data fields that include a date of the sale, a price, a quantity sold, an item ID, an item description, and a buyer. The computing system 120 may select two or more of the data fields to provide in the culling information. The computing system 120 may select the two or more data fields based on user input, initial programming, data structure of the data fields, current and/or previous user interaction with the computing system 120, machine learning, among other criteria. In some embodiments, the culling information may include the selected data fields. Alternately or additionally, the culling information may include the selected data fields and data values from the selected data fields.

As mentioned previously, the culling information may be used by a digital user interface to present various elements in the digital user interface. In some embodiments, the instructions for presenting the digital user interface may be provided by the computing system 120. In these and other embodiments, the digital user interface may be presented through a web browser. For example, the computing system 120 may provide computer readable instructions, such as HTML or other code, to the device 140, to allow the device 140 through the web browser, to render the digital user interface. Part of the instructions provided by the computing system 120 may include the culling information. The culling information may be used to configure the digital user interface and/or determine the configuration of individual elements in the digital user interface.

Alternately or additionally, the digital user interface may be a program installed on the device 140 that is run by the device 140 and/or a web browser on the device 140, such as a plug-in for a web browser. In these and other embodiments, the culling information may be provided to the device 140 to allow the device 140 to configure elements within the digital user interface.

In some embodiments, the culling information may be used to define a number and labeling of condition elements presented in the digital user interface. For example, identifier information of the data fields may be used to label the condition elements. The condition elements may be user selectable elements that indicate a data field that may be used as a basis by the computing system 120 to further cull the data entries that fulfill the initial request. For example, the culling information may include three data fields, such as a price field, a date field, and a quantity field. The condition elements presented in the digital user interface may be a price element, a date element, and a quantity element. The condition element selected by the user may indicate the data field of interest to the user and the data field that may be used to further cull the data entries in the database 130

The culling information may also be used to define values for a selection element in the digital user interface. The values for the selection element may be based on the condition element previously selected by a user. The selection element may be an element in the digital user interface that allows a user to select a particular value. The selected particular value may be used to cull the data entries of the database 130. The data entries of the database 130 that include data values in the data fields of the selected condition element that match or correspond with the selected particular value may be the culled data entries selected for presentation to the user through the device 140.

Data values may match or correspond based on a data field and conditions selected and/or determined for a particular data field. For example, if a selected data field is price and a selected data value is $15.00, data entries that include data values in the price data field within a particular margin of the $15.00 may be considered to match or correspond to the selected data value. The particular margin may be selected based on one or more of user input, differences between the data values among the data entries, among other criteria. For example, when the data values among the data entries result in no or less than a threshold of exact matches, the particular margin may be increased from an exact match until a threshold number of matches occur. In some embodiments, the threshold may be based on the device 140 that transmitted the request. For example, the threshold may be based on a size of the display 142 of the device 140. When the size of the display 142 is larger, the threshold may be larger and vice versa. Alternately or additionally, the threshold may be based on the connection speeds between the device 140 and the computing system 120 over the network 110. When the connection speeds are higher, the threshold may be higher and vice versa.

As an example, a condition element associated with a date of an item may be selected by a user. The culling information may include the lowest and highest values from the price data field from the data entries that fulfill the initial digital request. The selection element may present the lowest and highest values to a user and one or more values between the lowest and highest values. The user may select a particular value, e.g., a particular date, between or equal to the lowest or highest values. The selected particular value and the selected data field based on the selected condition element may be provided to the computing system 120. The computing system 120 may select the data entries with dates in the selected data field that match or correspond to the selected particular data. The computing system 120 may provide the selected data entries to the digital user interface for presentation to the user.

In this manner, in some embodiments, a number of data entries presented by the digital user interface may be reduced as compared to systems that do not include the additional culling. In some embodiments, no data entries responsive to the initial digital request may be presented until after presentation and selection of the condition element and values from the selection element and further culling of the data entries based on the selected condition elements and values. In these and other embodiments, only the selected data entries based on the selected condition elements and values may be presented by the device 140.

As described previously, the culling information may initially include both the selected data fields and the values for the selected data fields. In some embodiments, the culling information may initially include the selected data fields. After selection of a condition element associated with one of the selected data fields, the computing system 120 may obtain the data values for the one of the selected data fields. The computing system 120 may provide the data values for the one of the selected data fields as culling information to the digital user interface for presentation in the selection element.

Furthermore, in some embodiments, the digital user interface may be configured to obtain the selection of multiple condition elements and a data value for each selected condition element. The selected condition elements and associated data values may be provided to the computing system 120 for culling the database 130. In these and other embodiments, the data entries in the database 130 that are responses to the initial data request and that include values in the selected condition elements that match or correspond to the selected data values may be selected for presentation by the device 140.

Modifications, additions, or omissions may be made to the system 100 without departing from the scope of the present disclosure. For example, the information system 112 may include additional components and/or networks than those illustrated in or described with respect to FIG. 1. For example, the information system 112 may include additional databases, servers, and other computing systems configured to perform other tasks for the information system 112.

Alternately or additionally, the computing system 120 as described may be located outside of the information system 112. In these and other embodiments, the computing system 120 may be coupled to the network 110 and may access the database 130 over the network 110. Alternately or additionally, the database 130 may be separate from the information system 112. In these and other embodiments, the database 130 may be communicatively coupled to the network 110. Alternately or additionally, the computing system 120 and/or database 130 may be part of the device 140.

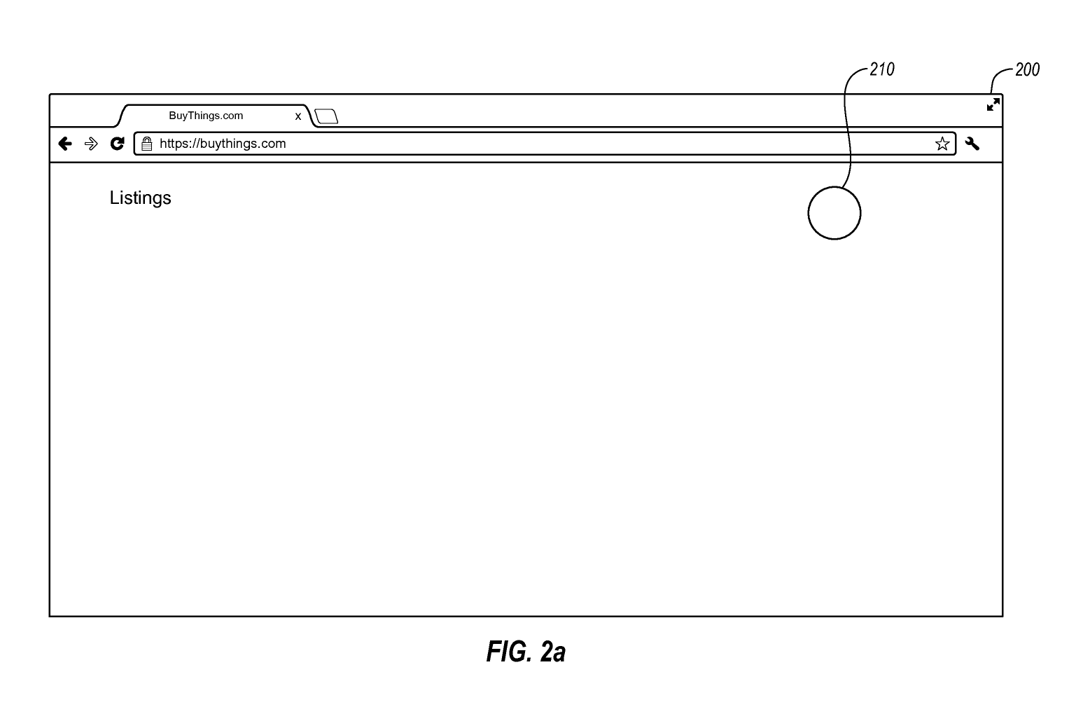

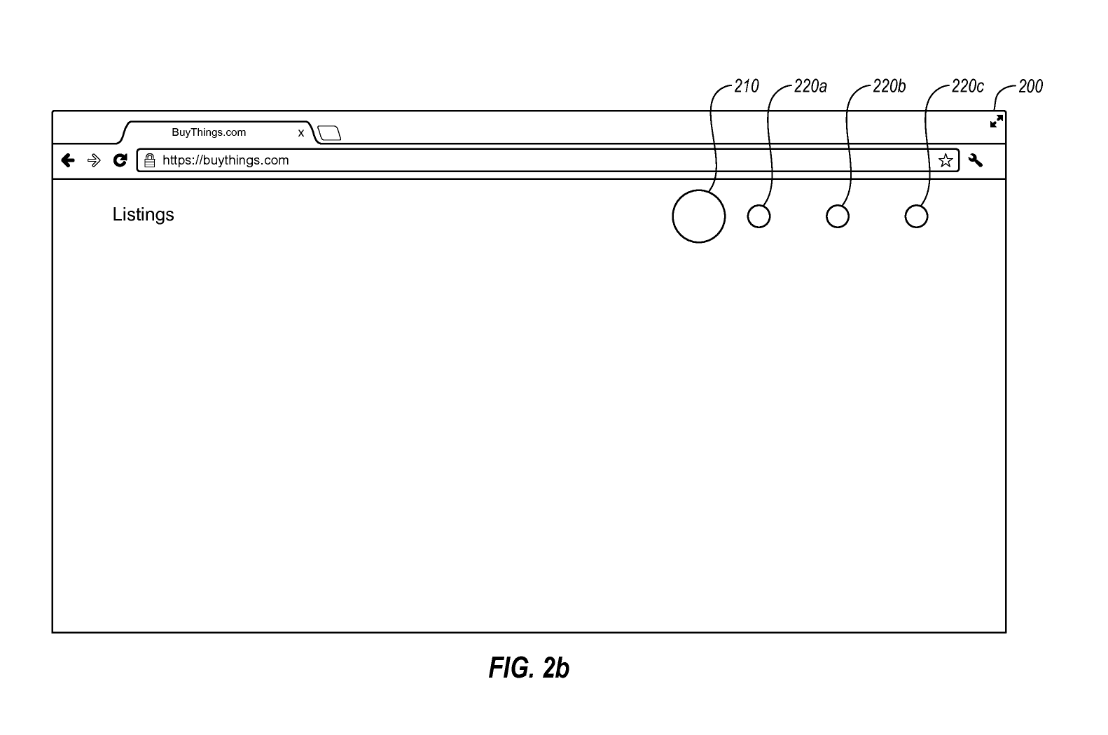

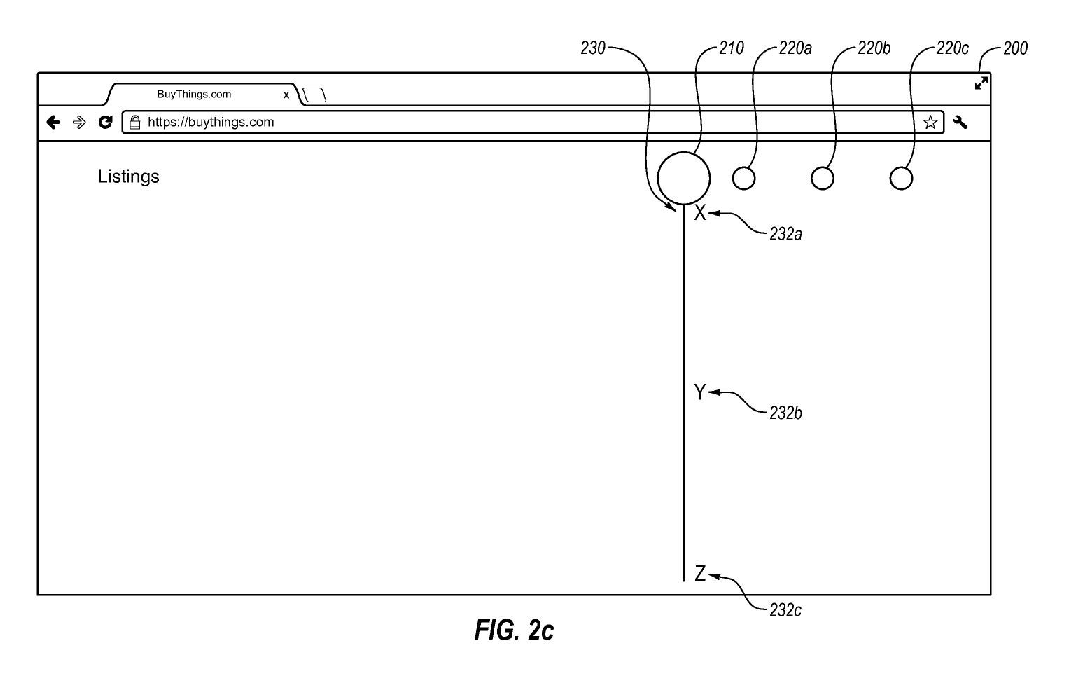

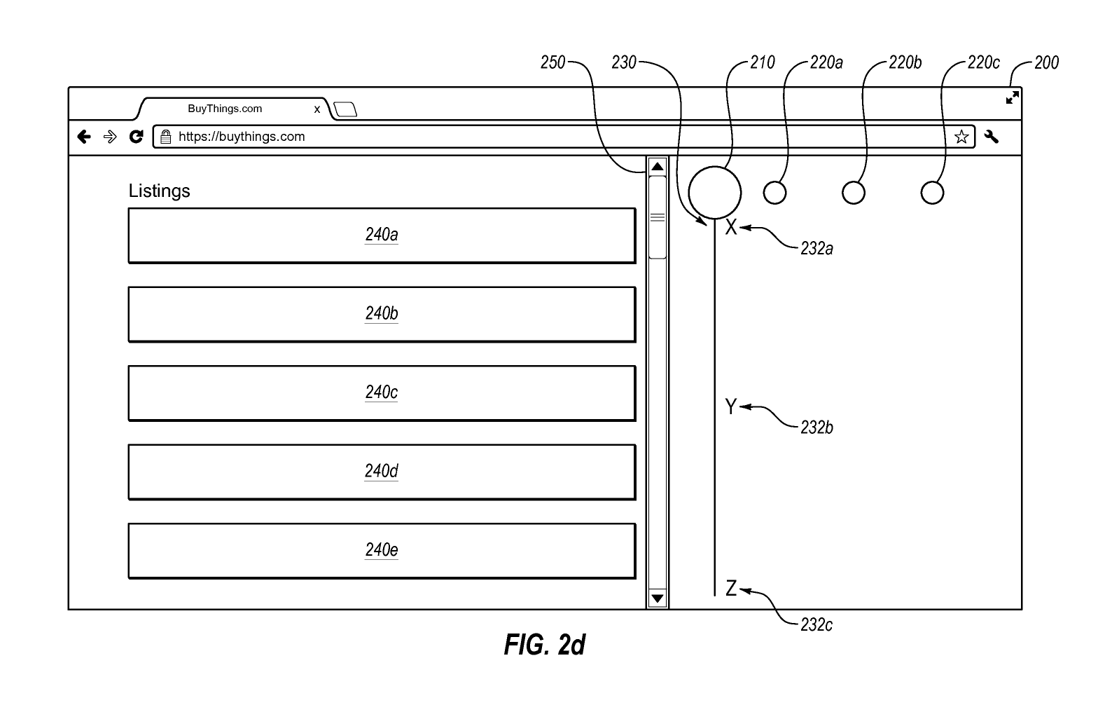

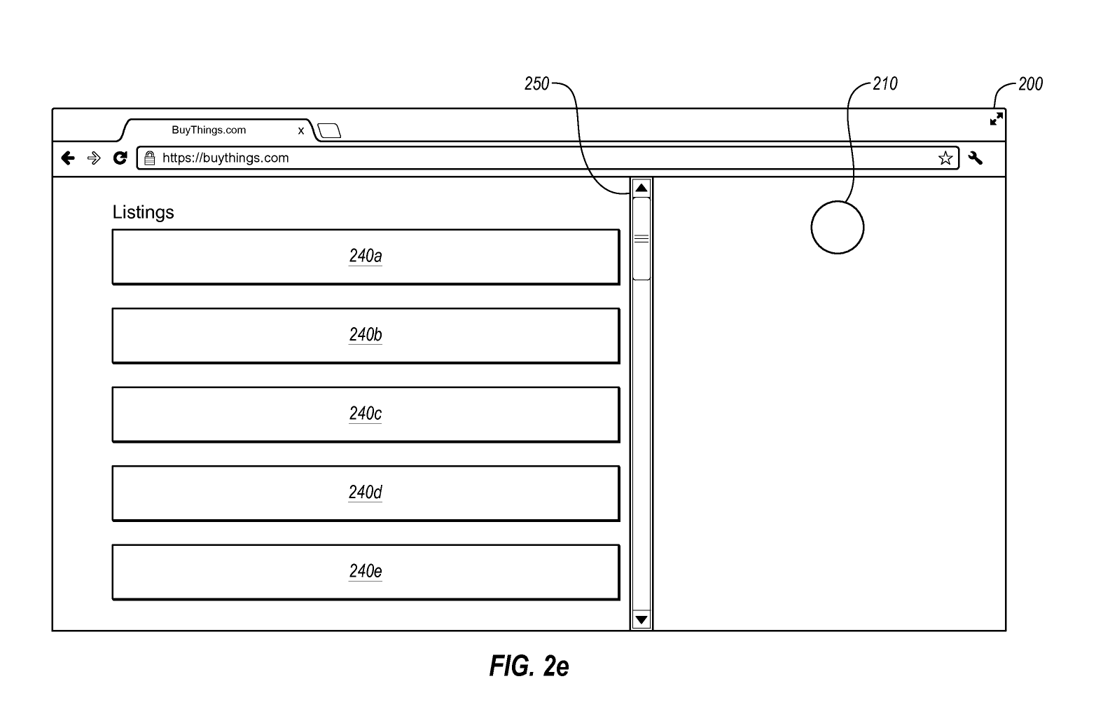

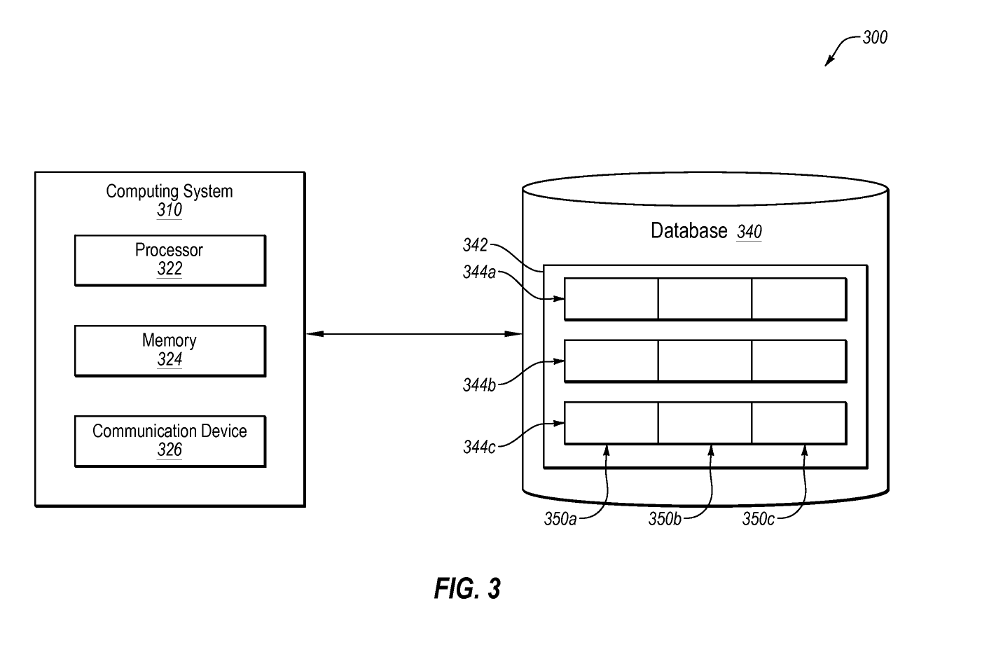

FIGS. 2a-2e illustrates examples of different configurations of a digital user interface 200 that presents digital information. The different configurations of the digital user interface 200 may be arranged in accordance with at least one embodiment described in the present disclosure. As illustrated in FIGS. 2a-2e, the digital user interface 200 may be implemented by a web browser or an application that is presenting a webpage based on instructions from a computing system. The computing system discussed with respect to FIGS. 2a-2e may be any computing system discussed or contemplated by this disclosure, such as the computing systems 120 or 310 of FIGS. 1 and 3. Alternately, the digital user interface 200 may be implemented by some other program based on instructions received from a computing system.

FIG. 2a may illustrate the digital user interface 200 that may be provided to a device from a computing system for presentation to a user in response to the reception of a request for data from the user at the computing system. Note that the digital user interface 200 does not include any listings or data that may be responsive to the user's request. The digital user interface 200 does include a presentation element 210. The presentation element 210 may be an interactive element. A user may interact with the presentation element 210 by navigating to or engaging with the presentation element 210. For example, a user hovering over or clicking on the presentation element 210 may be the user interaction with the presentation element 210.

FIG. 2b may illustrate the digital user interface 200 after user interaction with the presentation element 210. As illustrated in FIG. 2b, after the user interaction with the presentation element 210, a first condition element 220a, a second condition element 220b, and a third condition element 220c, collectively referred to as the condition elements 220, may be provided in the digital user interface 200.

A user may interact with the condition elements 220. In some embodiments, a user may select one or more of the condition elements 220. In some embodiments, a user interaction with the condition elements 220 may be different than how a user may interact with the presentation element 210. For example, the user interaction with the presentation element 210 may include hovering over the presentation element 210. When the presentation element 210 is hovered over, the condition elements 220 may appear. A user may interact with the condition elements 220 by engaging with the condition elements 220, for example, by clicking the condition elements 220.

In some embodiments, each of the condition elements 220 may include a different description or identifier. The descriptions or identifiers may be associated with different data fields in data entries in a database where the data entries are selected based on the user request previously submitted. For example, the user may submit a request for data. Based on the request, a computing system may determine data entries in a database that are responsive to the request. The computing system may generate culling information that includes an indication of some data fields in the response data entries, such as identifiers of the data fields. The culling information may be provided to the device that is rendering the digital user interface 200. Based on the culling information, the digital user interface 200 may present the condition elements 220. In some embodiments, the number of the condition elements 220 may be dynamically based on the culling information. For example, if the culling information indicates that there are X number of data fields then the digital user interface 200 may present X number of condition elements 220. Furthermore, the condition elements 220 may be presented with description or identifiers based on identifiers of the data fields that are included in the culling information. For example, the identifiers of the data fields in the culling information may be price and date. In this and other examples, the identifiers of the condition elements 220 may be price and date.

FIG. 2c may illustrate the digital user interface 200 after user interaction with one of the condition elements 220. As illustrated in FIG. 2c, after user interaction with one of the condition elements 220, the digital user interface 200 may present a selection element 230 that includes a first selection value 232a, a second selection value 232b, and a third selection value 232c, collectively referred to as the selection values 232.

The selection values 232 may represent one or more values from the data field associated with the selected one of the condition elements 220 from multiple data entries. For example, multiple data entries may include the same data field, such as price. The different values may each come from the same data field from the different data entries. For example, the first selection value 232a may come from the price data field of a first data entry, the second selection value 232b may come from the price data field of a second data entry, and the third selection value 232c may come from the price data field of a third data entry.

In some embodiments, the culling information with the information for the condition elements 220 may include the selection values 232. Alternately or additionally, after selection of one of the condition elements 220, the computing system may provide the selection values 232 associated with the selected one of the condition elements 220. The selection values 232 may include the lowest and highest values from the data field associated with the selected one of the condition elements 220. In some embodiments, the selection values 232 may include additional values from the data field associated with the selected one of the condition elements 220.

A user may interact with the selection element 230. In some embodiments, a user may select a value using the selection element 230. In some embodiments, the value that may be selected may be one of the selection values 232. Alternately or additionally, the selection element 230 may dynamically present values associated with the selection values 232 based on the location of the user interaction with the selection element 230. For example, the selection element 230 may present the selection values 232 as illustrated in FIG. 2c, with the first selection value 232a being the lowest value, the second selection value 232b being a middle value, and the third selection value 232c being the highest value. In these and other embodiments, a user may interact with the selection element 230 between the selection values 232, for example, by hovering over the line of the selection element 230 between the selection values 232. In these and other embodiments, the selection element 230 may dynamically display additional values based on the location of the interaction. For example, if the interaction is between the first selection value 232a and the second selection value 232b the dynamically displayed value may be between the lowest value and the middle value. The user may select one of the selection values 232 of the dynamically displayed values. In these and other embodiments, the selected value may be provided to the computing system. The computing system may further cull the data entries based on the selected value and the selected one of the condition elements 220 to select data entries for presentation to a user and provide the selected data entries to the digital user interface 200.

FIG. 2d may illustrate the digital user interface 200 after user interaction with one of the selection values 232. As illustrated in FIG. 2d, after user interaction with one of the selection values 232, the digital user interface 200 may present listings, illustrated in FIG. 2d as a first listing 240a, a second listing 240b, a third listing 240c, a fourth listing 240d, and a fifth listing 240e, collectively referred to as the listings 240, and a scroll bar 250. The listings 240 may present the data entries that include values that correspond to or match the selected value in the data field that corresponds with the selected one of the condition elements 220.

FIG. 2d illustrates five listings 240 as an example. In some embodiments, there may be more than five listings. If there are more listings than may be presented at one time by the digital user interface 200, the digital user interface 200 may include the scroll bar 250 to allow a user to change which of the listings is presented by the digital user interface 200.

FIG. 2e may illustrate the digital user interface 200 after presentation of the listings 240. As illustrated in FIG. 2e, after the presentation of the listings 240, the selection element 230 and the condition elements 220 may be removed from the digital user interface 200. In these and other embodiments, the presentation element 210 may continue to be presented in the digital user interface 200. If the user wants to obtain different listings, the user may interact with the presentation element 210 as described with respect to FIG. 2a to obtain additional listings for presentation by the digital user interface 200.

Modifications, additions, or omissions may be made to the digital user interface 200 without departing from the scope of the present disclosure. For example, in some embodiments, a user may select multiple of the condition elements 220. In these and other embodiments, the selection element 230 may present values for the selected multiple of the condition elements 220. Alternately or additionally, the presentation element 210 may be removed after the presentation of the condition elements 220. In these and other embodiments, the presentation element 210 may remained removed until after the removal of the condition elements 220.

FIG. 3 illustrates another example system 300 configured to present digital information. The system 300 may be arranged in accordance with at least one embodiment described in the present disclosure. The system 300 may include a computing system 310, which includes a processor 322, a memory 324, and a communication device 326, and a database 340.

The computing system 310 may be part of an on-line marketplace. The online marketplace may be any configuration of hardware, such as servers and databases, which are configured to provide an on-line marketplace for a seller or sellers to sell goods to buyers. For example, the on-line marketplace may be configured to provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. The prices set for a transaction may be auction-format listing and price setting mechanisms (e.g., English, Dutch, Chinese, Double, Reverse auctions, etc.). Other types of price listing formats may also be used. For example, a fixed-price listing format (e.g., the traditional classified advertisement-type listing or a catalogue listing) or a buyout-type listing format may be used. In these and other embodiments, a buyout-type listing may be offered in conjunction with auction-format listings and allow a buyer to purchase goods or services, which are also being offered for sale via an auction, for a fixed price that is typically higher than a starting price of an auction for an item.

The computing system 310 may be configured to provide information regarding the online marketplace. For example, the computing system 310 may provide information about items to buy. Alternately or additionally, the computing system 310 may provide information to sellers about items sold or information to buyers about items bought.

In some embodiments, the computing system 310 may include a processor 322 and a memory 324. In general, the processor 322 may include any suitable special-purpose or general-purpose computer, computing entity, or processing device including various computer hardware or software modules and may be configured to execute instructions stored on any applicable computer-readable storage media. For example, the processor 322 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, it is understood that the processor 322 may include any number of processors configured to perform individually or collectively any number of operations described herein. Additionally, one or more of the processors may be present on one or more different electronic devices, such as different servers. In some embodiments, the processor 322 may interpret and/or execute program instructions and/or process data stored in the memory 324. In some embodiments, the processor 322 may fetch program instructions and load the instructions in the memory 324. After the instructions are loaded into memory 324, the processor 322 may execute the program instructions to perform operations or methods described in this disclosure. For example, the processor 322 may fetch instructions from the database 340 regarding presenting a digital user interface, load the instructions into the memory 324, and execute the instructions to perform the operations described in this disclosure.

The memory 324 may include computer-readable storage media for carrying or having computer-executable instructions or data structures stored thereon. Such computer-readable storage media may be any available media that may be accessed by a general-purpose or special-purpose computer, such as the processor 322. By way of example, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 322 to perform a certain operation or group of operations.

The communication device 326 may include any component, device, system, or combination thereof configured to transmit or receive information. The communication device 326 may communicate with other devices at other locations, the same location, or even other components within the same system. The communication device 326 may include, without limitation, a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication device 326 may permit data to be exchanged with a network and/or any other devices described in the present disclosure.

The database 340 may be communicatively coupled with the computing system 310. The database 340 may include a first storage location 342 that includes a first data entry 344a, a second data entry 344b, and a third data entry 344c, collectively referred to as the data entries 344. Each of the data entries 344 may include a first data field 350a, a second data field 350b, and a third data field 350c, collectively referred to as the data fields 350.

As described previously with respect to other embodiments and/or FIGS., the computing system 310 may be configured to cull the data entries 344 of the database 340 based on an initial user query for information stored in the database 340. Based on the results of the initial user query, the computing systems 310 may determine which of the data fields 350 of the data entries 344 to provide in the culling information for use with condition elements in a digital user interface. The computing systems 310 may also query the database 340 to determine some of the values of the selected data fields 350 for use with the selection element. For example, the computing system 310 may determine a maximum and minimum value in the respective data fields.

In some embodiments, the computing system 310 may store past culling information. In these and other embodiments, when a similar user request is received, the computing system 310 may not query the database 340 but may provide the past culling information stored by the computing system 310.

In some embodiments, the data fields 350 may be the same or similar for some of, a majority of, or all of the data entries 344 in the database 340. In these and other embodiments, the computing system 310 may not query the database 340 to obtain the data fields, but only the values in the data fields 350.

Modifications, additions, or omissions may be made to the system 300 without departing from the scope of the present disclosure. For example, the computing system 310 and the database 340 may be communicatively coupled by a network, such as the network 110 of FIG. 1. Alternately or additionally, the system 300 may include multiple computing systems 310 and/or databases 340.

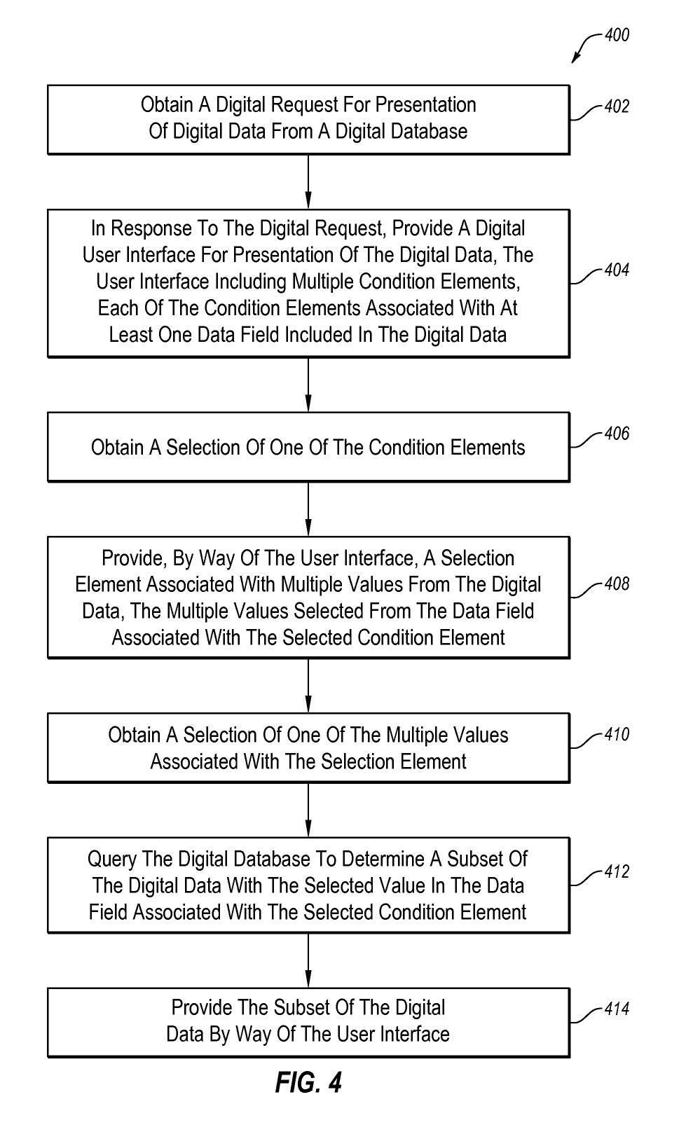

FIG. 4 is a flowchart of an example computer-implemented method 400 of digital information presentation. The method 400 may be arranged in accordance with at least one embodiment described in the present disclosure. The method 400 may be implemented, in some embodiments, by a system, such as the system 100 and/or 300 of FIGS. 1 and 3, respectively. Although illustrated as discrete blocks, various blocks may be divided into additional blocks, combined into fewer blocks, or eliminated, depending on the desired implementation.

The method 400 may begin at block 402, where a digital request for presentation of digital data from a digital database may be obtained.

In block 404, in response to the digital request, a digital user interface for presentation of the digital data may be provided. The user interface may include multiple condition elements. Each of the condition elements may be associated with at least one data field included in the digital data. In block 406, a selection of one of the condition elements may be obtained.

In block 408, a selection element associated with multiple values from the digital data may be provided by way of the user interface. The multiple values selected from the data field may be associated with the selected condition element. In some embodiments, only a subset of the multiple values is provided in the user interface by the selection element. In some embodiments, the multiple values may include a maximum value and minimum value from the data field associated with the selected condition element.

In block 410, a selection of one of the multiple values associated with the selection element may be obtained.

In block 412, the digital database may be queried to determine a subset of the digital data with the selected value in the data field associated with the selected condition element. In some embodiments, none of the digital data associated with the digital request is provided until the subset of the digital data is provided. In some embodiments, the subset of the digital data may be provided in response to the digital request in place of the presentation of all of the digital data or pagination of all of the digital data. In block 414, the subset of the digital data may be provided by way of the user interface

One skilled in the art will appreciate that, for this and other processes and methods disclosed herein, the functions and/or operations performed in the processes and methods may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For instance, in some embodiments, the method 400 may further include, stopping the presentation of the multiple condition elements and the selection element in the user interface after the providing of the subset of the digital data and while the subset of the digital data is still being presented.

In some embodiments, the user interface may further include a presentation element. In these and other embodiments, the method 400 may further include obtaining a selection of the presentation element. In some embodiments, in response to the selection of the presentation element, the user interface may present the multiple condition elements. In some embodiments, the selection of the condition elements and the selection of the presentation element may be the result of different user interactions with the user interface.

In some embodiments, the subset of the digital data may include a first subset of the digital data. In these and other embodiments, the method 400 may further include obtaining a selection of a second one of the condition elements and providing, in the user interface, a second selection element associated with multiple second values from the digital data, the multiple second values selected from the data field associated with the selected condition element. The method 400 may further include obtaining a selection of one of the multiple second values associated with the second selection element and querying the digital database to determine a second subset of the digital data that corresponds to the digital data that includes the selected second value in the data field associated with the selected second condition element and the selected value in the data field associated with the selected condition element. The method 400 may further include, in place of providing the first subset of the digital data, providing the second subset of the digital data in the user interface.

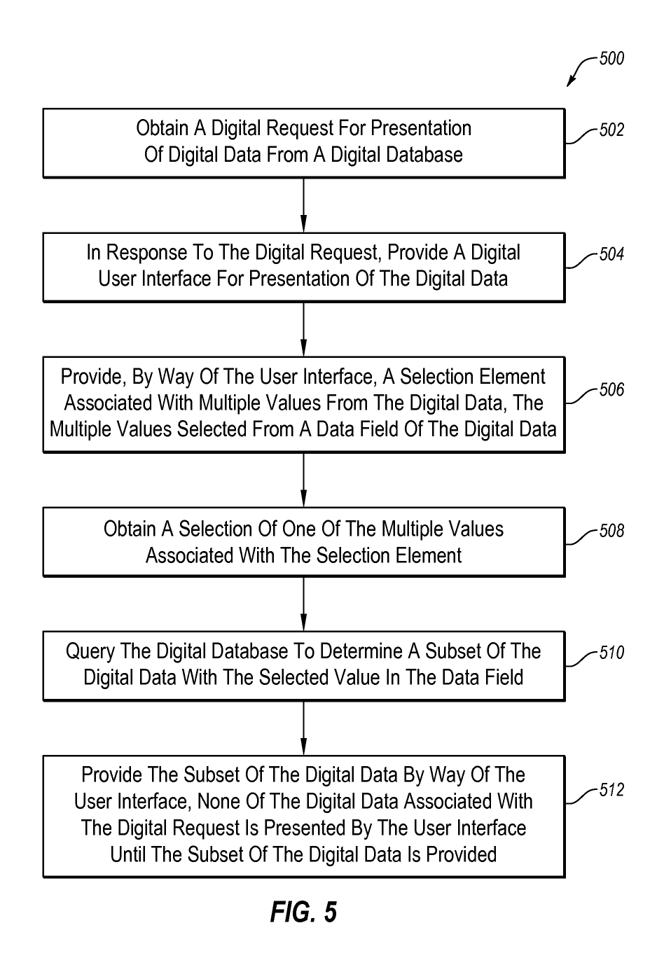

FIG. 5 is a flowchart of an example computer-implemented method 500 of digital information presentation. The method 500 may be arranged in accordance with at least one embodiment described in the present disclosure. The method 500 may be implemented, in some embodiments, by a system, such as the system 100 and/or 300 of FIGS. 1 and 3, respectively. Although illustrated as discrete blocks, various blocks may be divided into additional blocks, combined into fewer blocks, or eliminated, depending on the desired implementation.

The method 500 may begin at block 502, where a digital request for presentation of digital data from a digital database may be obtained.

In block 504, in response to the digital request, a digital user interface for presentation of the digital data may be provided.

In block 506, a selection element associated with multiple values from the digital data may be provided by way of the user interface. The multiple values may be selected from a data field of the digital data. In some embodiments, the user interface may include multiple condition elements. Each of the condition elements may be associated with at least one data field included in the digital data and the data field that includes the selected value may be associated with one of the condition elements. In some embodiments, the multiple values may include a maximum value and minimum value from the data field associated with the selected condition element.

In block 508, a selection of one of the multiple values associated with the selection element may be obtained. In block 510, the digital database may be queried to determine a subset of the digital data with the selected value in the data field.

In block 512, the subset of the digital data may be provided by way of the user interface. In these and other embodiments, none of the digital data associated with the digital request is presented by the user interface until the subset of the digital data is provided. In some embodiments, the subset of the digital data may be provided in response to the digital request in place of the presentation of all of the digital data or pagination of all of the digital data.

One skilled in the art will appreciate that, for this and other processes and methods disclosed herein, the functions and/or operations performed in the processes and methods may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 500 may further include obtaining a selection of one of the condition elements. In this and other embodiments, the one of the condition elements associated with the data field that includes the selected value is the selected one of the condition elements.

As indicated above, the embodiments described herein may include the use of a special purpose or general purpose computer (e.g., the processor 322 of FIG. 3) including various computer hardware or software modules, as discussed in greater detail below. Further, as indicated above, embodiments described herein may be implemented using computer-readable media (e.g., the memory 324 of FIG. 3) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order. Generally, the terms “first,” “second,” “third,” etc., are used to distinguish between different elements. Absence a showing of a specific that the terms “first,” “second,” “third,” etc., connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A computer-implemented method of digital information presentation, the method comprising:
obtaining a digital request for presentation of digital data from a digital database;
in response to the digital request, providing a digital user interface for presentation of the digital data, the user interface including a plurality of condition elements, each of the condition elements associated with at least one data field included in the digital data;
obtaining a selection of one of the condition elements;
providing, by way of the user interface, a selection element associated with a plurality of values from the digital data, the plurality of values selected from the data field associated with the selected condition element;
obtaining a selection of one of the plurality of values associated with the selection element;
querying the digital database to determine a subset of the digital data with the selected value in the data field associated with the selected condition element; and
providing the subset of the digital data by way of the user interface.

2. The computer-implemented method of claim 1, wherein only a subset of the plurality of values is provided in the user interface by the selection element.

3. The computer-implemented method of claim 1, wherein the plurality of values includes a maximum value and minimum value from the data field associated with the selected condition element.

4. The computer-implemented method of claim 1, wherein the user interface further includes a presentation element, the method further comprising obtaining a selection of the presentation element, wherein, in response to the selection of the presentation element, the user interface presents the plurality of condition elements.

5. The computer-implemented method of claim 4, wherein the selection of the condition elements and the selection of the presentation element are the result of different user interactions with the user interface.

6. The computer-implemented method of claim 1, wherein none of the digital data associated with the digital request is provided until the subset of the digital data is provided.

7. The computer-implemented method of claim 1, further comprising after the providing of the subset of the digital data and while the subset of the digital data is still being presented, stopping the presentation of the plurality of condition elements and the selection element in the user interface.

8. The computer-implemented method of claim 1, wherein the subset of the digital data is provided in response to the digital request in place of the presentation of all of the digital data or pagination of all of the digital data.

9. The computer-implemented method of claim 1, wherein the subset of the digital data is a first subset of the digital data, the method further comprising:
obtaining a selection of a second one of the condition elements;
providing, in the user interface, a second selection element associated with a plurality of second values from the digital data, the plurality of second values selected from the data field associated with the selected condition element; and
obtaining a selection of one of the plurality of second values associated with the second selection element;
querying the digital database to determine a second subset of the digital data that corresponds to the digital data that includes the selected second value in the data field associated with the selected second condition element and the selected value in the data field associated with the selected condition element; and
in place of providing the first subset of the digital data, providing the second subset of the digital data in the user interface.

10. A computer-implemented method of digital information presentation, the method comprising:
obtaining a digital request for presentation of digital data from a digital database;
in response to the digital request, providing a digital user interface for presentation of the digital data;
providing, by way of the user interface, a selection element associated with a plurality of values from the digital data, the plurality of values selected from a data field of the digital data;
obtaining a selection of one of the plurality of values associated with the selection element;
querying the digital database to determine a subset of the digital data with the selected value in the data field; and
providing the subset of the digital data by way of the user interface, wherein none of the digital data associated with the digital request is presented by the user interface until the subset of the digital data is provided.

11. The computer-implemented method of claim 10, wherein the user interface includes a plurality of condition elements, each of the condition elements associated with at least one data field included in the digital data and the data field that includes the selected value is associated with one of the condition elements.

12. The computer-implemented method of claim 11, wherein the method further comprises obtaining a selection of one of the condition elements, wherein the one of the condition elements associated with the data field that includes the selected value is the selected one of the condition elements.

13. The computer-implemented method of claim 10, wherein the subset of the digital data is provided in response to the digital request in place of the presentation of all of the digital data or pagination of all of the digital data.

14. The computer-implemented method of claim 10, wherein the plurality of values includes a maximum value and minimum value from the data field.

15. One or more non-transitory computer-readable media configured to store instructions that when executed by one or more processing systems performs operations, the operations comprising:
obtain a digital request for presentation of digital data from a digital database;
in response to the digital request, provide a digital user interface for presentation of the digital data, the user interface including a plurality of condition elements, each of the condition elements associated with at least one data field included in the digital data;
obtain a selection of one of the condition elements;
provide, by way of the user interface, a selection element associated with a plurality of values from the digital data, the plurality of values selected from the data field associated with the selected condition element;
obtain a selection of one of the plurality of values associated with the selection element;
query the digital database to determine a subset of the digital data with the selected value in the data field associated with the selected condition element; and
provide the subset of the digital data by way of the user interface.

16. The one or more non-transitory computer-readable media of claim 15, wherein the plurality of values includes a maximum value and minimum value from the data field associated with the selected condition element.

17. The one or more non-transitory computer-readable media of claim 15, wherein the user interface further includes a presentation element, wherein the operations further comprise obtain a selection of the presentation element, wherein, in response to the selection of the presentation element, the user interface provides the plurality of condition elements.

18. The one or more non-transitory computer-readable media of claim 15, wherein none of the digital data associated with the digital request is provided by way of the user interface until the provision of the subset of the digital data.

19. The one or more non-transitory computer-readable media of claim 15, wherein the operations further comprise after the provision of the subset of the digital data and while the subset of the digital data is still being presented, stop the presentation of the plurality of condition elements and the selection element in the user interface.

20. The one or more non-transitory computer-readable media of claim 15, wherein the subset of the digital data is provided in response to the digital request in place of the presentation of all of the digital data or pagination of all of the digital data.
